(19) United States
(12) Patent Application Publication
(10) Pub. No.: US 2003/0123409 A1
(43) Pub. Date: Jul. 3, 2003

(54) Apparatus and method for multiplexing/demultiplexing transport channels in a CDMA communication system

(75) Inventors: Yong-Jun Kwak, Yongin-shi (KR); Yong-Suk Moon, Songnam-shi (KR); Hun-Kee Kim, Seoul (KR); Sang-Hwan Park, Suwon-shi (KR); Jae-Seung Yoon, Songnam-shi (KR); Jae-Yoel Kim, Kunpo-shi (KR); Su-Won Park, Taejon-Kwangyok-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/273,277

(22) Filed: Oct. 17, 2002

(30) Foreign Application Priority Data
Oct. 17, 2001 (KR) 64129/2001

(51) Int. Cl. H04B 7/216

(52) U.S. Cl. 370/335; 370/537

(57) ABSTRACT

An apparatus and method for multiplexing/demultiplexing transport channels in an HSDPA (High Speed Downlink Packet Access) communication system. Upon generation of transport blocks to be transmitted to a UE (User Equipment), the transport blocks are concatenated to a transport block set. The transport block set is segmented into a plurality of code blocks according to the number of bits in the transport block set. The code blocks each are attached with CRC (Cyclic Redundancy Check) bits and mapped to transport channels.

### PRIORITY

This application claims priority to an application entitled “Apparatus and Method for Multiplexing/Demultiplexing Transport Channels in a CDMA Communication System” filed in the Korean Industrial Property Office on Oct. 17, 2001 and assigned Serial No. 2001-64129, the contents of which are hereby incorporated by reference.

### BACKGROUND OF THE INVENTION

1. Field of the Invention

The present invention relates generally to a W-CDMA (Wideband Code Division Multiple Access) communication system using an HSDPA (High Speed Downlink Packet Access) scheme, and in particular, to an apparatus and method for multiplexing/demultiplexing transport channels.

2. Description of the Related Art

HSDPA brings high-speed data delivery to terminals over the HS-DSCH (High Speed-Downlink Shared Channel) and related control channels. To support HSDPA, AMC (Adaptive Modulation and Encoding), HARQ (Hybrid Automatic Retransmission Request), and FCS (Fast Cell Selection) have been proposed.

AMC: This is a technique for adapting a modulation and encoding format based on a received signal quality of a UE (User Equipment) and a channel condition between a particular Node B and the UE to increase a use efficiency of an entire cell. Therefore, the AMC involves a plurality of modulation and encoding schemes (MCSs). MCS levels are set from level 1 to level n for AMC. In other words, the AMC is an adaptive selection of an MCS level according to the channel condition between the UE and the serving Node B.

HARQ, particularly n-channel SAW HARQ (n-channel Stop And Wait HARQ): Two techniques are introduced to increase typical ARQ efficiency. That is, a retransmission request and a response for the retransmission request are exchanged between the UE and the Node B, and defective data is temporarily stored and combined with corresponding retransmitted data. The n-channel SAW HARQ has been introduced to overcome the shortcomings of conventional SAW ARQ in HSDPA. In the SAW ARQ, a next packet data is not transmitted until an ACK (Acknowledgement) signal is received for a previously transmitted packet data. This implies that even though the packet data can be transmitted, the ACK signal must be awaited. On the other hand, the n-channel SAW HARQ allows successive transmission of next packet data without receiving an ACK signal for transmitted packet data, thereby increasing channel use efficiency. If n logical channels are established between a UE and a Node B, and are identified by specific time or their channel numbers, the UE can determine a channel on which packet data has been transmitted at an arbitrary time point. The UE also can rearrange packet data in a correct reception order or soft-combine corresponding packet data.

FCS: This is a technique for fast selecting a cell (hereinafter, referred to as a best cell) at the best condition among a plurality of cells when a UE supporting HSDPA is at a soft-handover zone defined as an overlapped zone between Node Bs. When the UE enters the soft-handover region, it establishes radio links with the Node Bs. The cells of the Node Bs that have established radio links with the UE are the active set of the UE. The UE receives data only from the best cell in the active set to thereby reduce overall interference. The UE periodically monitors the channel conditions with the cells in the active set to determine if there is a cell better than the present best cell. If such a cell is detected, the UE transmits a Best Cell Indicator (BCI) to the cells of the active set to change the best cell. The BCI contains an identification (ID) of the new best cell. Upon receipt of the BCI, the cells determine whether the BCI indicates them. Then, the new best cell transmits an HSDPA packet to the UE on the HS-DSCH.

To support AMC, HARQ and FCS, an HSDPA communication system adopts a different transport channel structure or physical channel structure from that in a non-HSDPA communication system, for example, Release 99 or Release 4. In HSDPA, a primary interleaver is not used and TTI (Transmission Time Interval), which is 10, 20, 40, or 80 ms in the conventional non-HSDPA communication systems, is 2 ms, bringing different physical mapping.

Particularly due to the changed transport channel structure and multiplexing of transport channels, a CCTrCH (Coded Composite Transport Channel) is generated in a different manner than in Release 99. Consequently, different interleaving and physical channel mapping are used.

FIG. 1 schematically illustrates HARQ in an HSDPA communication system. Referring to FIG. 1, a Node B 10 transmits an HS-DSCH signal 30 to a UE 20. The UE 20 determines whether the HS-DSCH signal 30 has errors by CRC (Cyclic Redundancy Check). If the HS-DSCH signal 30 turns out to be defective, the UE 20 transmits an NACK (Negative Acknowledgement) signal 40 for the HS-DSCH signal 30 to the Node B 10. The Nod B 10 then retransmits the HS-DSCH signal 30 to the UE 20. On the other hand, if the HS-DSCH signal 30 is normal, the UE 20 transmits an ACK signal 40 for the HS-DSCH signal 30 to the Node B 10. The Node B 10 then transmits a new HS-DSCH signal 30 to the UE 20.

FIG. 2 illustrates a downlink channel structure in the HSDPA communication system. Referring to FIG. 2, a DL-DPCH (Downlink Dedicated Physical Channel) is always transmitted along with the HS-DSCH. The DL-DPCH includes an HI (High-speed Indicator) field 201 indicating whether HSDPA service data exists. If the HI indicates a presence of HSDPA service data, the UE reads an SHCCH (Shared Control Channel) in predetermined time slots 203. The UE reads a corresponding TTI 207 on the HS-DSCH a predetermined time, for example, τ_{HS-DSCH}_{_{—}}_{control} 205, after starting to read the time slots. The HS-DSCH TTI is 2 ms, as stated before.

FIG. 3 is a block diagram of an uplink channel transmitter for transmitting feedback information for an HS-DSCH signal in the HSDPA communication system. Referring to FIG. 3, after receiving the HS-DSCH signal, the UE transmits feedback information for the HS-DSCH signal to the Node B on a new defined secondary DPCCH (Dedicated Physical Control Channel).

An ACK/NACK bit 301 in the secondary DPCCH delivers an ACK or NACK to report to the Node B whether the HS-DSCH signal has errors, for HARQ. The ACK/NACK bit 301 occurs ten times by repetition in a repeater 303 to provide robustness against errors to the ACK/NACK signal. Four channel quality bits 302 transmit channel quality information so that the Node B can determine an MCS level for the HS-DSCH. The channel quality bits 302 are fed to a block encoder 304 to take robustness against errors. The block encoder 304 performs (20, 4) block encoding. Thus it outputs 20-bit coded channel quality information for the four channel quality bits 302. The ACK/NACK information and the channel quality information are multiplexed and mapped to one slot of one HSDPA TTI (=3 slots) and the other two slots, respectively on the secondary DPCCH.

FIG. 4 illustrates a typical transport channel multiplexing mechanism in the HSDPA communication system. HS-DSCH multiplexing illustrated in FIG. 4 is currently under discussion for standardization. When transport blocks (TrBks) are received at a physical layer from a MAC (Medium Access Channel) layer in step 401, they are concatenated to one transport block set (TBS) in step 402. After a CRC is attached to the TBS in step 403, the TBS is segmented into code blocks for error correction encoding in step 404. The CRC is 24 bits. The code blocks are channel-encoded in step 405 and their rates are matched by puncturing or repetition in step 406. The rate-matched data blocks are segmented into frames to be transmitted on physical channels in step 407 and secondarily interleaved to prevent burst errors in step 408. The interleaved data blocks in frames are mapped to the physical channels in step 409 and transmitted on the physical channels phCH#1 and PhCH#2 in step 410.

The CRC attachment following the TrBK concatenation to TBS brings about inefficient HARQ implementation and adds to the load of the UE in the HSDPA communication system.

### SUMMARY OF THE INVENTION

It is, therefore, an object of the present invention to provide a transport channel multiplexing apparatus and method for increasing HARQ efficiency for a transport channel signal in an HSDPA communication system.

To achieve the above and other objects, in a physical channel multiplexing apparatus of a transmitter, a transport block concatenator concatenates transport blocks to a transport block set when a plurality of transport blocks are input. A code block segmenter segments the transport block set into a plurality of code blocks of a size equal to or larger than a maximum code block size, if the transport block set is larger than the maximum code block size. A CRC adder adds CRC bits to each of the code blocks, a channel encoder channel-encodes the code blocks at the same code rate and outputs a plurality of coded bit streams. A rate matcher receives the coded bit streams in one serial coded bit stream and matches the rate of the serial coded bit stream to have a number of bits transmittable on the physical channels. Finally, a physical channel generator segments the rate-matched coded bit stream by the number of the physical channels and maps the segmented coded bit streams to the physical channels.

In a physical channel demultiplexing apparatus of a receiver, a physical channel concatenator concatenates received data mapped to a plurality of physical channels to one data stream. A channel decoder segments the data stream into a plurality of coded bit streams of the same size, decodes the coded bit streams at the same code rate, and outputs code blocks. A CRC checker performs an error check on each of the code blocks by CRC bits in the code block and transmits the error check results to the transmitter on an uplink channel. A code block concatenator concatenates the code blocks to one transport block set. Finally, a transport block segmenter segments the transport block set into a plurality of transport blocks of the same size.

### BRIEF DESCRIPTION OF THE DRAWINGS

The above and other objects, features and advantages of the present invention will become more apparent from the following detailed description when taken in conjunction with the accompanying drawings in which:

FIG. 1 schematically illustrates HARQ in an HSDPA communication system;

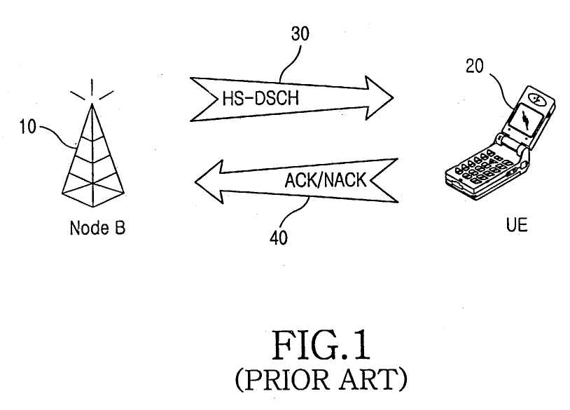

FIG. 2 illustrates a downlink channel structure in the HSDPA communication system;

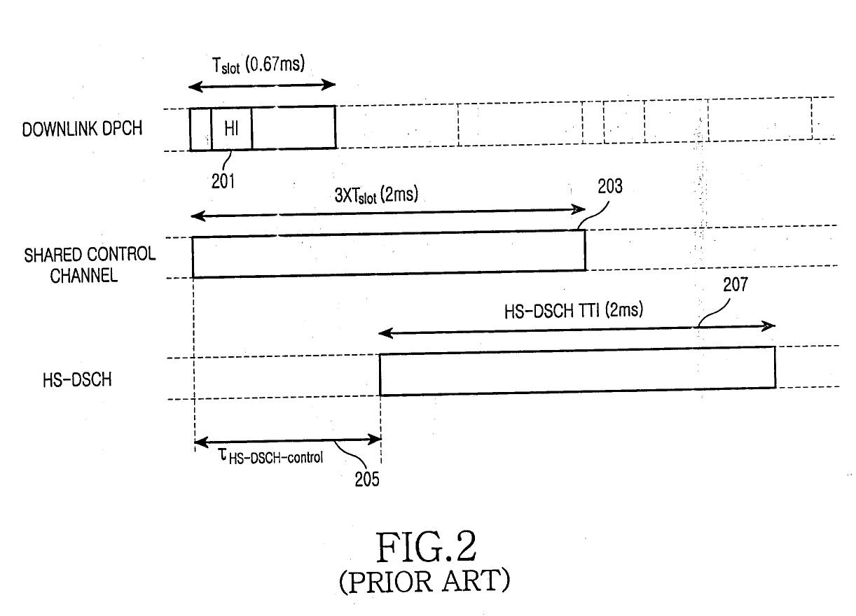

FIG. 3 is a block diagram of an uplink channel transmitter in the HSDPA communication system;

FIG. 4 illustrates a typical transport channel multiplexing mechanism in the HSDPA communication system;

FIG. 5 illustrates a transport channel multiplexing method in an HSDPA communication system according to an embodiment of the present invention;

FIG. 6 illustrates transport channel multiplexing when QPSK and a code rate of ¼ are used as an MCS and 10 code channels are used;

FIG. 7 illustrates transport channel demultiplexing corresponding to the transport channel multiplexing illustrated in FIG. 6;

FIG. 8 illustrates transport channel multiplexing when 16QAM and a code rate of ¾ are used as an MCS and 5 code channels are used;

FIG. 9 illustrates transport channel demultiplexing corresponding to the transport channel multiplexing illustrated in FIG. 8;

FIG. 10 illustrates transport channel multiplexing when 64QAM and a code rate of ¾ are used as an MCS and 10 code channels are used;

FIG. 11 is a block diagram of an uplink channel transmitter in the HSDPA communication system according to the embodiment of the present invention;

FIG. 12 illustrates the structure of an uplink channel generated in the uplink channel transmitter illustrated in FIG. 11;

FIG. 13 is a block diagram of a Node B according to the embodiment of the present invention; and

FIG. 14 is a block diagram of a UE according to the embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

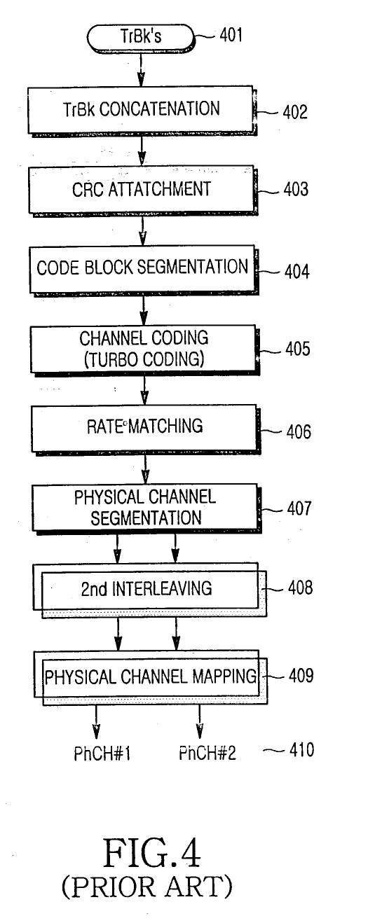

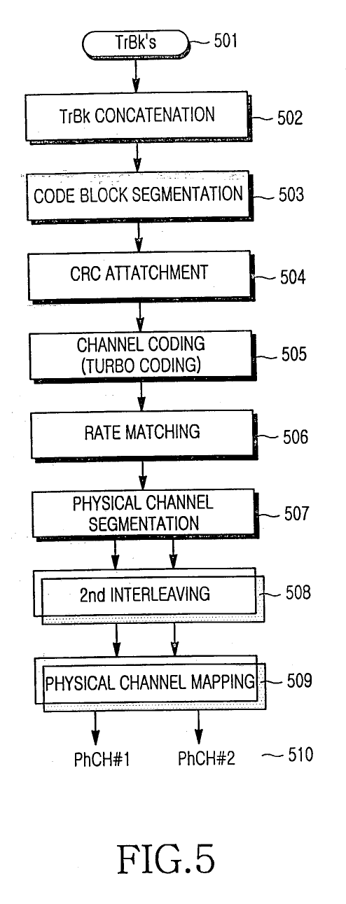

FIG. 5 illustrates a transport channel multiplexing method in HSDPA communication system according to an embodiment of the present invention. Referring to FIG. 5, transport channel multiplexing according to the present invention is performed in the same manner as the typical transport channel multiplexing illustrated in FIG. 4, except that code block segmentation in step 503 is accompanied by CRC attachment in step 504. A code block has up to 5114 bits. The CRC attachment after the code block segmentation improves HARQ performance.

(1) Transmission of an ACK or NACK signal for a received HS-DSCH signal depends on the CRC check result of the signal. If a CRC check indicates that the HS-DSCH signal has errors, a UE transmits the NACK signal as feedback information to a Node B. If the HS-DSCH signal has no errors, the UE transmits the ACK signal as feedback information to the Node B. In the typical transport channel multiplexing, a CRC check is available after all code blocks are channel-decoded because code block segmentation follows CRC attachment in the Node B. On the contrary, a CRC check can be performed in the units of a code block in the embodiment of the present invention because code block segmentation precedes CRC attachment. Accordingly, it is possible to generate ACK or NACK feedback information in real time for an individual code block, thus improving HARQ performance.

(2) Buffering of previously received information can be reduced in HARQ, leading to the decrease of memory capacity constraints in the UE. The CRC attachment after the code block segmentation allows an error check to be carried out after decoding an individual code block. Therefore, only defective code blocks are stored, decreasing a memory capacity requirement in the UE. Furthermore, since only defective data is soft-combined with its retransmitted data, processing time is shortened and power is saved.

(3) A novel HARQ technique is facilitated. In the above HARQ operation, multi-feedback is enabled, that is, ACK/NACK signals can be transmitted in pairs. The resulting retransmission of defective coded blocks only improves HARQ performance.

The CRC attachment following code block segmentation according to the embodiment of the present invention will be described in more detail.

Table 1 below lists code block sizes, etc. with respect to MCS levels in the HS-DSCH multiplexing.

TABLE 1
SF = 16, TrBk size: 240 bits

| | | Number | | Number | Code | Number |
|---|---|---|---|---|---|---|
| | | of | | of code | block | of channel |
| index | MCS | TrBks | Bits/TTI | blocks | size | codes |
| 1 | QPSK, | 5 | 1200 | 1 | 1200 | 5 |
| | rate 1/4 | | | | | |
| 2 | QPSK, | 15 | 3600 | 1 | 3600 | 5 |
| | rate 3/4 | | | | | |
| 3 | 16QAM, | 20 | 4800 | 1 | 4800 | 5 |
| | rate 1/2 | | | | | |
| 4 | 16QAM, | 30 | 7200 | 2 | 3600 | 5 |
| | rate 3/4 | | | | | |
| 5 | 64QAM, | 45 | 10800 | 3 | 3600 | 5 |
| | rate 3/4 | | | | | |
| 6 | QPSK, | 10 | 2400 | 1 | 2400 | 10 |
| | rate 1/4 | | | | | |
| 7 | QPSK, | 30 | 7200 | 2 | 3600 | 10 |
| | rate 3/4 | | | | | |
| 8 | 16QAM, | 40 | 9600 | 2 | 4800 | 10 |
| | rate 1/2 | | | | | |
| 9 | 16QAM, | 60 | 14400 | 3 | 4800 | 10 |
| | rate 3/4 | | | | | |
| 10 | 64QAM, | 90 | 21600 | 5 | 4320 | 10 |
| | rate 3/4 | | | | | |

(Rule 1) according to the embodiment of the present invention will be described referring to Table 1.

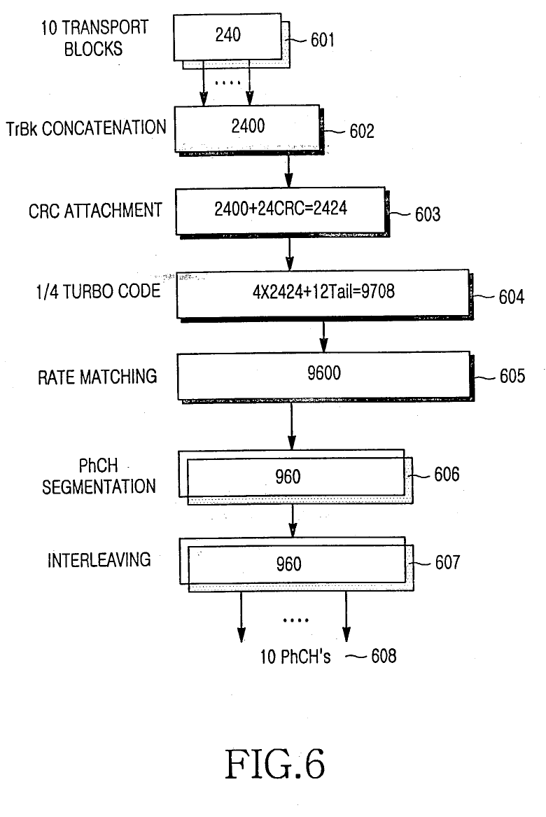

FIG. 6 illustrates transport channel multiplexing when conditions of index 6 in Table 1 (QPSK, a code rate of ¼, and use of 10 code channels) are applied to the transport channel multiplexing mechanism illustrated in FIG. 5.

Referring to FIG. 6, the size of one TrBk is 240 bits and 10 TrBks form one 2400-bit TBS in step 602. Since the TBS is smaller than the maximum code block size 5114 bits, code block segmentation is not needed. Thus, the TBS becomes one code block and is attached with a 24-bit CRC in step 603. The CRC-attached code block is channel-coded at a code rate of ¼ in step 604 and the resulting 9708 coded bits are reduced to 9600 bits by rate matching in step 605. Since SF (Spreading Factor) is 16 and QPSK is used as a modulation scheme, one code channel transmits 960 bits in one TTI. Since 10 code channels are used and thus 9600 bits in total can be transmitted on the 10 code channels, the 9708 bits are rate-matched to the 9600 bits. The rate-matched coded bits are segmented according to physical channels (code channels) in step 606. That is, the 9600 bits are segmented to 10×960 bits. The segmented coded bits are interleaved to prevent burst errors in step 607, and the interleaved bits are transmitted on the 10 code channels in step 608. The physical channels can be HS-PDSCHs (High Speed Physical Downlink Shared Channels).

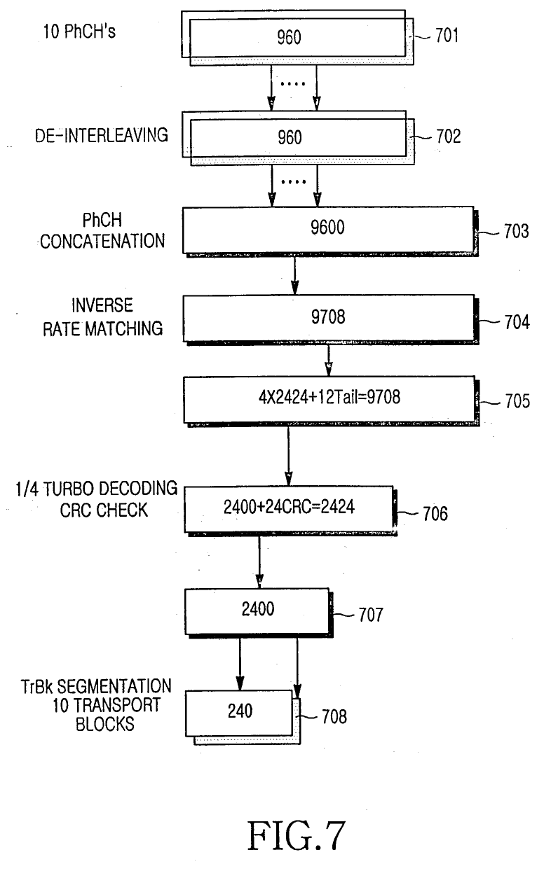

Now demultiplexing the multiplexed HS-PDSCH illustrated in FIG. 6 will be described with reference to FIG. 7.

Referring to FIG. 7, upon receipt of 10 multiplexed 960-bit HS-PDSCH signals from the Node B in step 701, the UE deinterleaves the HS-PDSCH signals individually in step 702. Then the deinterleaved HS-PDSCH signals are concatenated to one 9600-bit physical channel data in step 703. The physical channel data is recovered to the original 9708 bits by inverse rate-matching in step 704. The 9708 bits are turbo-decoded at a code rate of ¼ and 2424 bits including 2400 information bits and a 24-bit CRC are output in step 705. The turbo-decoded data is CRC-checked for error detection in step 706. If the HS-PDSCH data has errors, the UE transmits an NACK signal for the HS-PDSCH data to the Node B. On the other hand, if the HS-PDSCH data is normal, a 2400-bit TBS with the 24-bit CRC eliminated is segmented into 10 240-bit TrBks in step 707 and the TrBks are output in step 708.

As described above, when multiplexing and demultiplexing are carried out under the conditions of QPSK and a code rate of ¼ as an MCS level and data transmission on 10 code channels, a TBS is smaller than a code block size. Therefore, the Node B transmits CRC-attached data without code block segmentation. The UE correspondingly generates an ACK/NACK signal after a CRC check on each code block of physical channel signals. Under the conditions of index 6 in Table 1, transport channel multiplexing is performed in the same manner as the typical transport channel multiplexing. The same thing occurs to index 1, index 2, and index 3. Yet transport channel multiplexing under the conditions at the other indexes in Table 1 offers multiplexing advantages according to the embodiment of the present invention because a TrBk is larger than a code block.

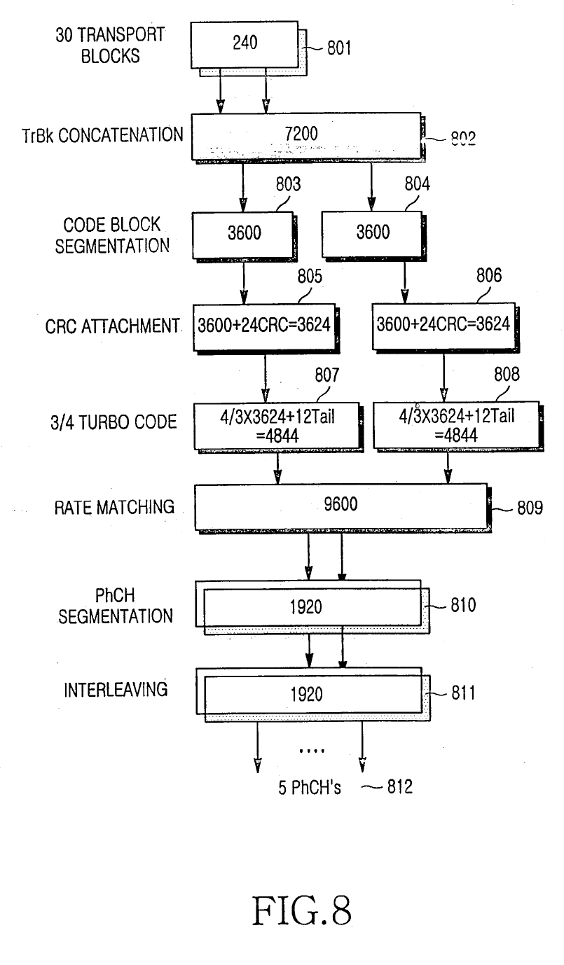

Transport channel multiplexing under the conditions of 16QAM, a code rate of ¾, and 5 code channels at index 4 in Table I will be described with reference to FIG. 8.

Referring to FIG. 8, the size of one TrBk is 240 bits in step 801 and 30 TrBks form one 7200-bit TBS in step 802. Since the TBS is larger than the maximum code block size 5114 bits, code block segmentation is needed. Thus, the TBS is segmented into two 3600-bit code blocks in steps 803 and 804. The code blocks are attached with 24-bit CRCs in steps 805 and 806, respectively. The CRC-attached code blocks are channel-coded at a code rate of ¾ and two 4844-bit streams, each including 12 tail bits are output in steps 808 and 809. The sum 9688 bits of the two streams are rate-matched to 9600 bits in step 809. Since SF is 16 and 16QAM is used as a modulation scheme, one code channel transmits 1920 bits in one TTI. Since 5 code channels are used and thus 9600 bits in total can be transmitted on the 5 code channels, the 9688 bits are rate-matched to the 9600 bits in step 809. The rate-matched coded bits are segmented according to physical channels in step 810. That is, the 9600 bits are segmented to 5×1920 bits. The segmented coded bits are interleaved to prevent burst errors in step 811, and transmitted on the 5 code channels in step 812. The physical channels are HS-PDSCHs.

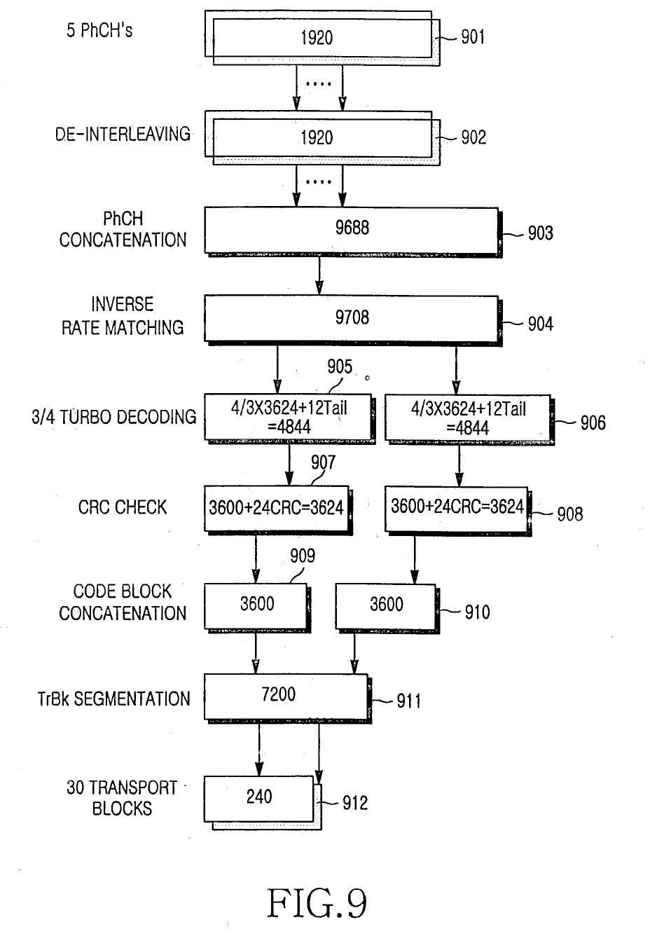

Now demultiplexing the HS-PDSCH multiplexed in the procedure illustrated in FIG. 8 will be described with reference to FIG. 9. Referring to FIG. 9, upon receipt of 5 multiplexed 1920-bit HS-PDSCH signals from the Node B in step 901, the UE deinterleaves the HS-PDSCH signals individually in step 902. Then the deinterleaved HS-PDSCH signals are concatenated to one 9688-bit physical channel data in step 903. The physical channel data is recovered to the original 9708 bits by deratematching in step 904. The 9708 bits are segmented into two 4844-bit code blocks and turbo-decoded at a code rate of ¾ in steps 905 and 906. Each decoded bit stream has 3624 bits. The decoded bit streams are CRC-checked for error detection in steps 907 and 908. The CRC check is performed on the individual code blocks. If a specific code block has errors, the UE transmits an NACK signal for the code block to the Node B. The CRC check on a code block basis allows feedback of an NACK signal for a defective code block without waiting until all the code blocks are demodulated. Therefore, HARQ time is reduced. On the other hand, if all the code blocks are normal, the CRC-checked data, that is, two 3600-bit code blocks with 24-bit CRCs removed are concatenated to one 7200-bit stream in steps 909 and 910. The bit stream is segmented into 30 240-bit TrBks in step 911 and the 30TrBks are output in step 912.

Upon receipt of NACK feedback information from the UE, the Node B retransmits a corresponding code block to the UE by HARQ. The retransmitted code block may be the same as or different from the previously transmitted code block. In the latter case, the retransmitted code block includes new parity information closely related to the previously transmitted code block and they may have a different numbers of bits. Thus, the retransmitted code block may be different in size from a code block illustrated in FIGS. 8 and 9.

The UE demultiplexes the retransmitted HS-PDSCH signal in the procedure according to the embodiment of the present invention.

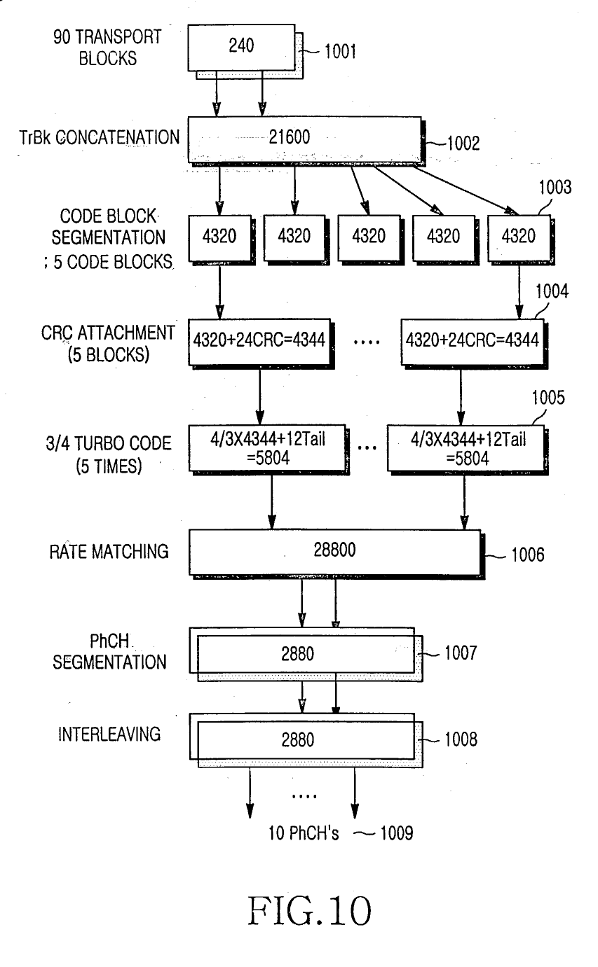

Transport channel multiplexing under the conditions of 64QAM, a code rate of ¾, and 10 code channels at index 10 in Table 1 will be described with reference to FIG. 10. Referring to FIG. 10, the size of one TrBk is 240 bits in step 1001 and 90 TrBks form one 21600-bit TBS in step 1002. Since the TBS is larger than the maximum code block size 5114 bits, code block segmentation is needed. Thus, the TBS is segmented into five 4320-bit code blocks in step 1003. Each of the code blocks is attached with a 24-bit CRC in step 1004. Each of the CRC-attached code blocks is channel-coded at a code rate of ¾ and 5 5804-bit streams, each including 12 tail bits are output in step 1005. The sum of the bit streams is rate-matched in step 1006. Since SF is 16 and 64QAM is used as a modulation scheme, one code channel transmits 2880 bits in one TTI. Since 10 code channels are used and thus 29020 bits in total can be transmitted on the 10 code channels, the 29020 bits are rate-matched to 28800 bits. The rate-matched bit stream is segmented according to physical channels in step 1007. That is, the 28800 bits are segmented to 10×2880 bits. The segmented coded bits are interleaved to prevent burst errors in step 1008, and transmitted on the 10 code channels in step 1009. The physical channels are HS-PDSCHs.

Demultiplexing the transmitted HS-PDSCH signals in the UE is performed in the same manner as illustrated in FIG. 9 except that different parameters are used.

The physical channel multiplexing and demultiplexing described referring to FIGS. 8, 9, and 10 offers the following benefits.

(1) A CRC check can be performed on a code block basis, thereby enabling fast feedback information transmission and fast retransmission.

(2) NACK information is fed back only for a defective code block and thus only retransmission information corresponding to the NACK information is soft-combined. As a result, the size of a buffer for temporarily storing received information for soft combining can be minimized and soft combining time can also be reduced. Errors in normal code blocks caused by soft-combining of defective code blocks together with the normal code blocks, as encountered in the typical HARQ, are avoided.

(3) When soft-combining of retransmission information is impossible in HARQ, only a corresponding defective code block is newly decoded and CRC-checked. If the code block has no errors, data is obtained from the code block using the retransmission information only.

A method of improving the performance of the multiplexing method in which CRC attachment occurs after code block segmentation when data retransmission can be performed in the units of a code block and ACK/NACK feedback information is also transmitted correspondingly will be described below.

In an HARQ technique using the transport channel multiplexing structure according to the embodiment of the present invention, ACK/NACK feedback information must be transmitted on a code block basis to allow data retransmission on a code block basis. This multi-ACK/NACK information transmission increases retransmission efficiency and improves HARQ performance. To implement the multi-ACK/NACK information transmission, however, the structure of an ACK/NACK information field on an uplink secondary DPCH must be modified.

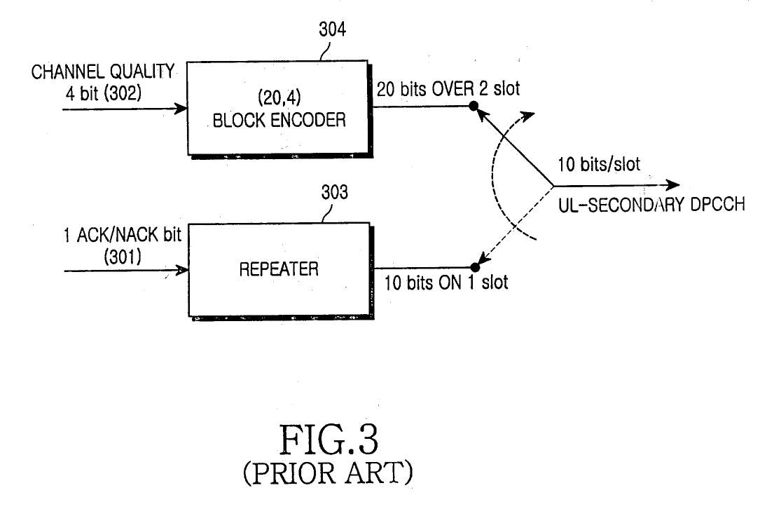

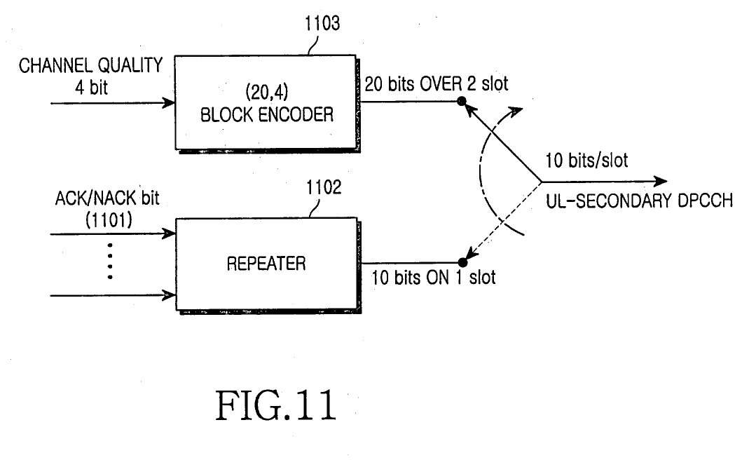

FIG. 11 is a block diagram of an uplink secondary DPCH transmitter according to an embodiment of the present invention. Referring to FIG. 11, the uplink secondary DPCH is generated in the same manner as the typical uplink secondary DPCH described referring to FIG. 3, except that a plurality of ACK/NACK bits 1101 are used instead of one ACK/NACK bit 1101. The plurality of ACK/NACK bits 1101 provides feedback information for individual code blocks. The number of the ACK/NACK bits 1101 is equal to the number of code blocks received by one transport channel signal.

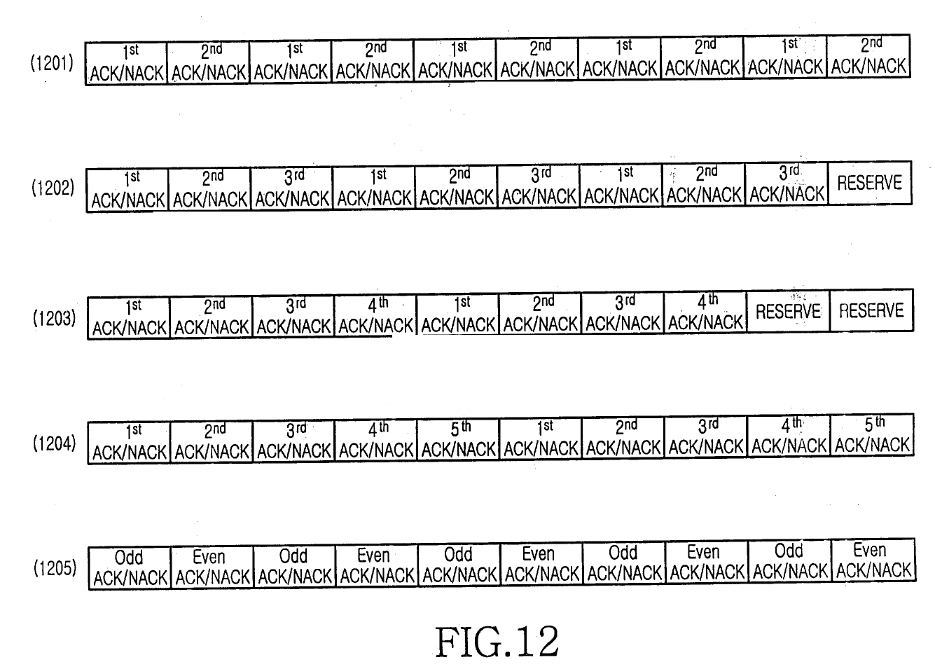

FIG. 12 illustrates examples of multi-ACK/NACK information transmission in the uplink secondary PDCH transmitter illustrated in FIG. 11. One transport channel delivers two or more code blocks and ACK/NACK information is transmitted for each code block on the uplink secondary DPCH.

Referring to FIG. 12, reference numeral 1201 denotes transmission of two code blocks on one HS-PDSCH, reference numeral 1202 denotes transmission of three code blocks on one HS-PDSCH, reference numeral 1203 denotes transmission of four code blocks on one HS-PDSCH, reference numeral 1204 denotes transmission of five code blocks on one HS-PDSCH, and reference numeral 1205 denotes transmission of an indefinite number of code blocks on one HS-PDSCH. In 1205, the code blocks are divided into two groups and ACK/NACK information is transmitted for each group, thereby reducing complexity in consideration of the fixedness of the ACK/NACK field.

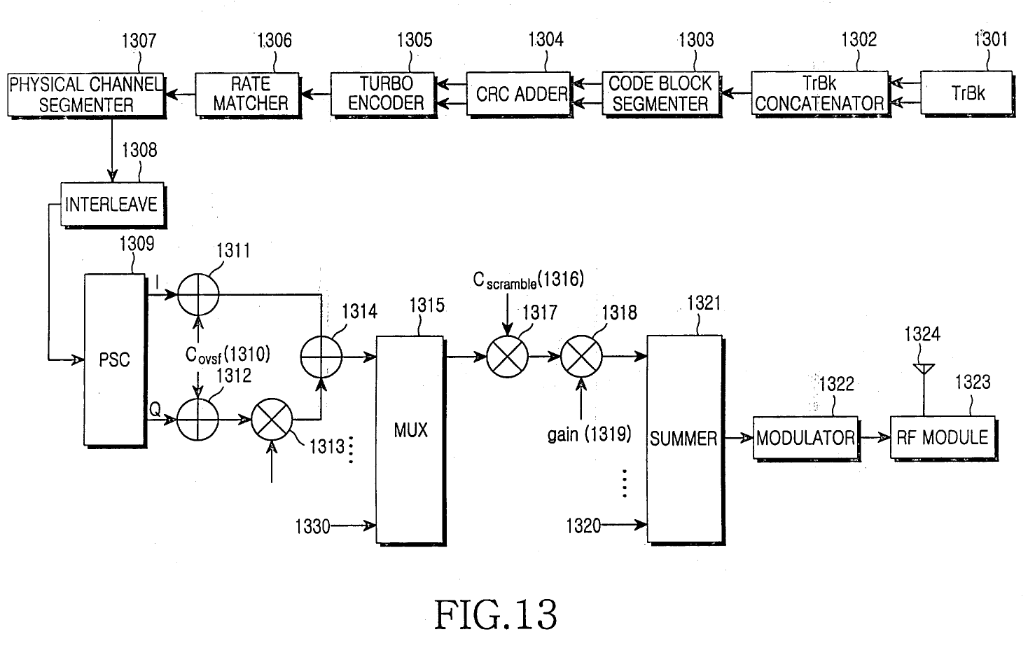

FIG. 13 is a block diagram of a Node B according to the embodiment of the present invention. Referring to FIG. 13, a TrBk concatenator 1302 concatenates TrBks 1301 received from an upper layer to one TBS. A code block segmenter 1303 outputs the TBS as a code block if the TBS is equal to or smaller than a code block size, and segments the TBS into code blocks if the TBS is larger than the code block size. A CRC adder 1304 adds a CRC to each code block received from the code block segmenter 1303. A turbo encoder 1305 encodes each CRC-attached code block received from the CRC adder 1304 at a predetermined code rate and outputs the coded bit streams in one code bit stream.

A rate matcher 1306 matches the rate of the coded bit stream to be suitable for transmission on physical channels. A physical channel segmenter 1307 segments the rate-matched coded bit stream according to the physical channels. An interleaver 1308 individually interleaves the segmented code bit streams received from the physical channel segmenter 1307 in a predetermined interleaving method. A serial-to-parallel converter (SPC) 1309 converts the interleaved signals to I and Q channel signals. Multipliers 1311 and 1312 multiply the I and Q channel signals by a channelization code C_{OVSF} 1310, respectively. A multiplier 1313 multiplies the output of the multiplier 1312 by a signal j. An adder 1314 adds the output of the multiplier 1311 to the output of the multiplier 1313. A multiplexer (MUX) 1315 multiplexes the output of the adder 1314 with other channel signals 1330. A multiplier 1317 multiplies the multiplexed signal by a scrambling code C_{SCRAMBLE} 1316. Thus the multiplier 1317 functions as a scrambler. A multiplier 1318 multiples the scrambled signal by a channel gain 1319. A summer 1321 sums the output of the multiplier 1318 and other channel signals 1320. A modulator 1322 modulates the output of the summer 1321 in a predetermined modulation scheme. An RF (Radio Frequency) module 1323 converts the modulated signal to an RF band for transmission in the air. Finally, an antenna 1324 transmits the RF signal to the air.

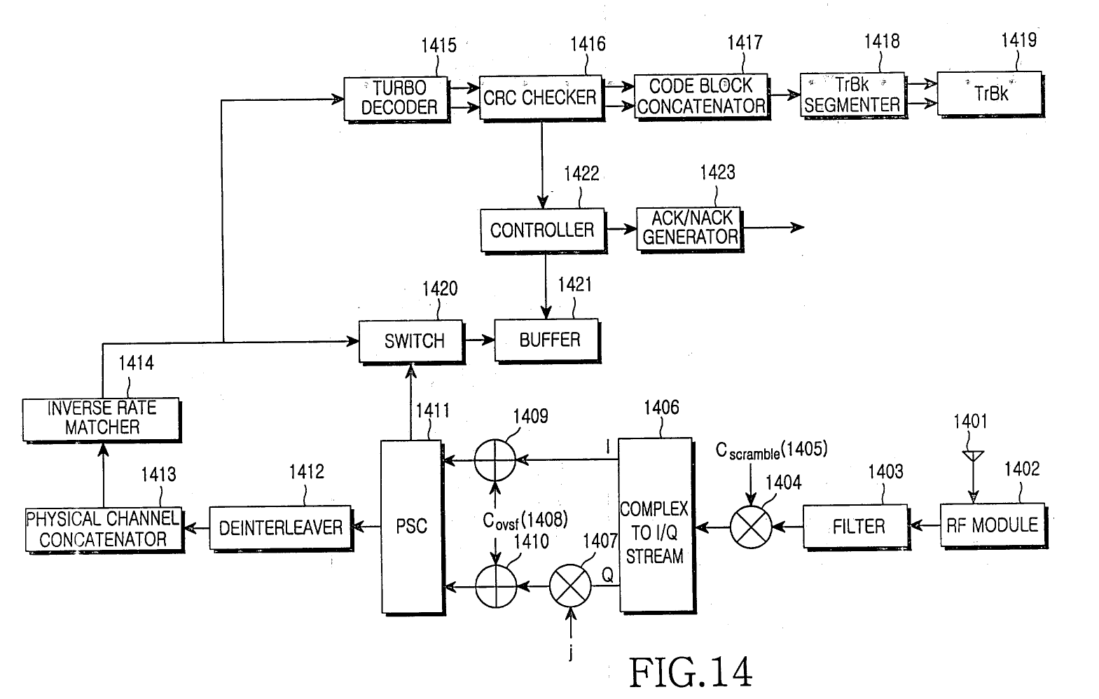

FIG. 14 is a block diagram of a UE for receiving a signal from the Node B illustrated in FIG. 13. Referring to FIG. 14, an RF module 1402 processes an RF signal received through an antenna 1401. A filter 1403 filters the output of the RF module 1402 according to a frequency band for the UE. A multiplier 1404 multiplies the filtered signal by the same scrambling code C_{SCRAMBLE} 1405 as used in the Node B. Thus the multiplier 1404 functions as a descrambler.

A complex to I/Q stream unit 1406 separates the descrambled signal into an I channel signal and a Q channel signal. A multiplier 1409 multiplies the I channel signal by the same channelization code C_{OVSF} 1408 as used in the Node B. A multiplier 1407 multiplies the Q channel signal by a signal j. A multiplier 1410 multiplies the output of the multiplier 1407 by the channelization code C_{OVSF} 1408. A parallel-to-serial converter (PSC) 1411 converts the outputs of the multipliers 1409 and 1410 to a serial signal and feeds the serial signal to a deinterleaver 1412 and a switch 1420. The serial signal is demultiplexed subsequently.

The deinterleaver 1412 deinterleaves the serial signal by physical channels in a deinterleaving method corresponding to the interleaving in the Node B. A physical channel concatenator 1413 concatenates the interleaved coded bit streams of the physical channels to one coded bit stream. An inverse rate matcher 1414 performs inverse rate matching on the coded bit stream in correspondence with rate matching in the Node B. The switch 1420 selects one of the data at a symbol level received from the PSC 1411 and the data at a bit level received from the inverse rate matcher 1414.

Meanwhile, a turbo decoder 1415 segments the code bit stream received from the inverse rate matcher 1414 into a plurality of code blocks and decodes each of the code blocks according to the code rate used in the Node B. A CRC checker 1416 CRC-checks each of the decoded bit streams received from the turbo decoder 1415. If it turns out that a specific code block has errors, the CRC checker 1416 reports the defective code block to a controller 1422. The controller 1422 then controls an ACK/NACK generator 1423 to generate an NACK signal for the defective code block. The NACK signal is transmitted to the Node B on the uplink secondary DPCH. At the same time, the controller 1422 controls the buffer 1421 to store the defective code block. On the other hand, if all the code blocks are normal, the CRC checker 1416 reports to the controller 1422 that they are all normal. The controller 1422 then controls the ACK/NACK generator 1423 to generate ACK signals for the code channels. The ACK signals are transmitted to the Node B on the uplink secondary DPCH. Here, the ACK/NACK generator 1423 can generate an NACK signal on a code block basis. The CRC checker 1416 removes CRC bits from the decoded bit streams after the CRC check. A code block concatenator 1417 concatenates the code blocks received from the CRC checker 1416 to one TBS. A TrBk segmenter 1418 segments the TBS into TrBks 1419.

In accordance with the present invention as described above, code block segmentation precedes CRC attachment in multiplexing of transport channels to be transmitted to a UE in an HSDPA communication system. The UE carries out a CRC check on a code block basis to determine whether to request a retransmission of received data. The resulting reduced ACK/NACK feedback time maximizes HARQ efficiency. Buffering only defective code blocks leads to minimization of a buffer capacity requirement. Furthermore, only a defective code block is soft-combined with its retransmission code block, thereby improving soft combining performance.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A physical channel multiplexing method in a transmitter that maps at least one transport block to a plurality of physical channels prior to transmission in a CDMA (Code Division Multiple Access) mobile communication system, comprising the steps of:
concatenating transport blocks to a transport block set when a plurality of transport blocks are input, and segmenting the transport block set into a plurality of code blocks of a size equal to or larger than a maximum code block size if the transport block set is larger than the maximum code block size;
adding CRC (Cyclic Redundancy Check) bits to each of the code blocks, channel-encoding the code blocks at a same code rate, and outputting a plurality of coded bit streams;
receiving the coded bit streams in one serial coded bit stream and rate-matching the serial coded bit stream to have a number of bits transmittable on the physical channels; and
segmenting the rate-matched coded bit stream by a number of the physical channels and mapping the segmented coded bit streams to the physical channels.

2. The method of claim 1, further comprising the step of interleaving the segmented coded bit streams individually.

3. The method of claim 1, wherein the maximum code block size is 5114 bits.

4. The method of claim 1, wherein the physical channels are high-speed downlink physical common channels (HS-DPCHs).

5. A physical channel multiplexing apparatus in a transmitter that maps at least one transport block to a plurality of physical channels prior to transmission in a CDMA (Code Division Multiple Access) mobile communication system, comprising:
a transport block concatenator for concatenating transport blocks to a transport block set when a plurality of transport blocks are input;
a code block segmenter for segmenting the transport block set into a plurality of code blocks of a size equal to or larger than a maximum code block size if the transport block set is larger than the maximum code block size;
a CRC (Cyclic Redundancy Check) adder for adding CRC bits to each of the code blocks;
a channel encoder for channel-encoding the code blocks at a same code rate and outputting a plurality of coded bit streams;
a rate matcher for receiving the coded bit streams in one serial coded bit stream and matching a rate of the serial coded bit stream to have a number of bits transmittable on the plurality of physical channels; and
a physical channel generator for segmenting the rate-matched coded bit stream by a number of the physical channels and mapping the segmented coded bit streams to the physical channels.

6. The apparatus of claim 5, further comprising an interleaver for interleaving the segmented coded bit streams individually.

7. The apparatus of claim 5, wherein the maximum code block size is 5114 bits.

8. The apparatus of claim 5, wherein the physical channels are high-speed downlink physical common channels (HS-DPCHs).

9. A physical channel demultiplexing method in a receiver that receives data mapped to a plurality of physical channels from a transmitter in a CDMA (Code Division Multiple Access) mobile communication system, comprising the steps of:
concatenating received data mapped to a plurality of physical channels to one data stream, segmenting the data stream into a plurality of coded bit streams of a same size, decoding the coded bit streams at a same code rate, and outputting code blocks;
performing an error check on each of the code blocks by CRC (Cyclic Redundancy Check) bits in the code block and transmitting the error check results to the transmitter on an uplink channel; and
concatenating the code blocks to one transport block set and segmenting the transport block set into a plurality of transport blocks of a same size.

10. The method of claim 9, wherein the physical channels high-speed downlink physical common channels (HS-DPCHs).

11. The method of claim 9, wherein the uplink channel is an uplink secondary dedicated physical control channel (DPCH).

12. A physical channel demultiplexing apparatus in a receiver that receives data mapped to a plurality of physical channels from a transmitter in a CDMA (Code Division Multiple Access) mobile communication system, comprising:
a physical channel concatenator for concatenating received data mapped to a plurality of physical channels to one data stream;
a channel decoder for segmenting the data stream into a plurality of coded bit streams of a same size, decoding the coded bit streams at a same code rate, and outputting code blocks;
a CRC (Cyclic Redundancy Check) checker for performing an error check on each of the code blocks by CRC bits in the code block and transmitting the error check results to the transmitter on an uplink channel;
a code block concatenator for concatenating the code blocks to one transport block set; and
a transport block segmenter for segmenting the transport block set into a plurality of transport blocks of a same size.

13. The apparatus of claim 12, wherein the physical channels high-speed downlink physical common channels (HS-DPCHs).

14. The apparatus of claim 12, wherein the uplink channel is an uplink secondary dedicated physical control channel (DPCH).
